(19) United States
(12) Patent Application Publication
(10) Pub. No.: US 2020/0031628 A1
(43) Pub. Date: Jan. 30, 2020

(54) ELEVATOR CAR APRON

(71) Applicant: Otis Elevator Company, Farmington, CT (US)

(72) Inventor: Nicolas Fonteneau, Chateauneuf Sur Loire (FR)

(21) Appl. No.: 16/509,971

(22) Filed: Jul. 12, 2019

(30) Foreign Application Priority Data
Jul. 26, 2018 (EP) 18306010.2

(51) Int. Cl. B66B 13/28; B66B 11/02; B66B 13/30

(52) U.S. Cl. CPC B66B 13/285; B66B 13/301; B66B 11/0226

(57) ABSTRACT

Elevator systems are provided. The systems include an elevator car movable along an elevator shaft, the shaft having a pit floor and a shaft top, the elevator car having an elevator car door sill, a plurality of landings arranged along the elevator shaft, wherein each landing has a landing door, and a car apron assembly. The car apron assembly includes a semi-rigid curtain attached to the elevator car door sill at a first end of the semi-rigid curtain. The semi-rigid curtain folds from a deployed state to a folded state when contacting the pit floor, and, when in the deployed state, the semi-rigid curtain extends below the elevator car to block an open landing door that is lower than the elevator car when the elevator car is positioned offset and above an adjacent landing.

### BACKGROUND

The subject matter disclosed herein generally relates to elevator systems and, more particularly, to elevator car aprons and safety mechanisms for elevator systems.

Traditional safety requirements for elevator shafts have led to larger spaces both at the top and bottom of the elevator shaft. However, such enlarged spaces may be disadvantageous for architectural reasons. Thus, elevator lift manufacturers have attempted to reduce hoistway or elevator shaft overhead dimensions and pit depth while maintaining safety features. Mechanics currently go to the top of car, or on top thereof, or in the pit, for inspection or maintenance activity of various components of an elevator car system. Thus, safety spaces or volumes are employed within the elevator shaft to protect a mechanic in the event of an emergency and thus require increased overhead and pit dimensions.

Further advancements and designs have attempted to completely eliminate the need for a mechanic to enter the hoistway, thus improving safety. An advantage of eliminating the need for entering the hoistway is that the traditional large pit depths may be reduced such that very small pit depths may be employed in such elevator systems.

Elevator cars typically include a toe guard or car apron situated beneath the elevator car door. The car apron is arranged to prevent persons from falling into an elevator shaft if the elevator car is not located at a landing and the landing doors are opened. The car apron is typically rigid and has a nominal height of about 750 mm. A significant amount of clearance beneath the elevator car is required to avoid contact between the car apron and the bottom of the elevator shaft when the elevator car is situated at a lowest landing. Such contact could cause significant damage to the car apron due to the rigid and fixed nature of the car apron. Accordingly, retractable car aprons have been proposed to address the above issues for systems employing small pit depths. However, improved systems may be advantageous.

### BRIEF SUMMARY

According to some embodiments, elevator systems are provided. The elevator systems include an elevator car movable along an elevator shaft, the shaft having a pit floor and a shaft top, the elevator car having an elevator car door sill, a plurality of landings arranged along the elevator shaft, wherein each landing has a landing door, and a car apron assembly. The car apron assembly includes a semi-rigid curtain attached to the elevator car door sill at a first end of the semi-rigid curtain. The semi-rigid curtain folds from a deployed state to a folded state when contacting the pit floor, and when in the deployed state the semi-rigid curtain extends below the elevator car to block an open landing door that is lower than the elevator car when the elevator car is positioned offset and above an adjacent landing.

In addition to one or more of the features described above, or as an alternative, further embodiments may include that the semi-rigid curtain is formed from at least one of rubber, plastic, fabric, metallic chain links, plastic chain links, metal mesh, and plastic mesh.

In addition to one or more of the features described above, or as an alternative, further embodiments may include that the car apron assembly further comprises a first support element that is a weighted element that applies a downward force on the semi-rigid curtain.

In addition to one or more of the features described above, or as an alternative, further embodiments may include that the first support element located at a second end of the semi-rigid curtain.

In addition to one or more of the features described above, or as an alternative, further embodiments may include that the car apron assembly further comprises at least one second support element arranged to guide the semi-rigid curtain along the elevator shaft below the elevator car.

In addition to one or more of the features described above, or as an alternative, further embodiments may include at least one guiding element extending between the elevator shaft top and the pit floor, wherein the at least one second support element engages with the at least one guiding element as the elevator car moves along the elevator shaft.

In addition to one or more of the features described above, or as an alternative, further embodiments may include that the at least one guiding element is a rope or cable and the at least one second support element is a ring that slides along the rope or cable.

In addition to one or more of the features described above, or as an alternative, further embodiments may include that the at least one guiding element is a guide rail and the at least one second support element is a guide shoe that engages and moves along the guide rail.

In addition to one or more of the features described above, or as an alternative, further embodiments may include that the at least one guiding element attaches to a top anchor at the elevator shaft top and a base anchor at the pit floor

In addition to one or more of the features described above, or as an alternative, further embodiments may include that the semi-rigid curtain provides a horizontal resistance of between 200-700 N with a 5-50 mm deflection, in particular with a horizontal resistance of about 300 N with about a 35 mm deflection.

In addition to one or more of the features described above, or as an alternative, further embodiments may include that the semi-rigid curtain has a length of between 1 and 5 meters in the deployed state and between 0 and 500 mm in the folded state, in particular having a length of about 2 meters in the deployed state and about 300 mm in the folded state.

In addition to one or more of the features described above, or as an alternative, further embodiments may include that each landing door has a height H_{d} and the semi-rigid curtain has a length L_{c}, wherein the curtain length L_{c} is equal to or greater than half the landing door height H_{d}, in particular wherein the curtain length L_{c} is greater than the landing door height H_{d}.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited by the accompanying figures in which like reference numerals indicate similar elements.

FIG. 1 is a schematic illustration of an elevator system that may employ various embodiments of the present disclosure;

FIG. 2 is a schematic illustration of an elevator system that may employ embodiments of the present disclosure;

FIG. 3 is a schematic illustration of an elevator system having a car apron assembly in accordance with an embodiment of the present disclosure; and

FIGS. 4A-4C are a sequence of schematic illustrations of operation of a car apron assembly in accordance with an embodiment of the present disclosure.

### DETAILED DESCRIPTION

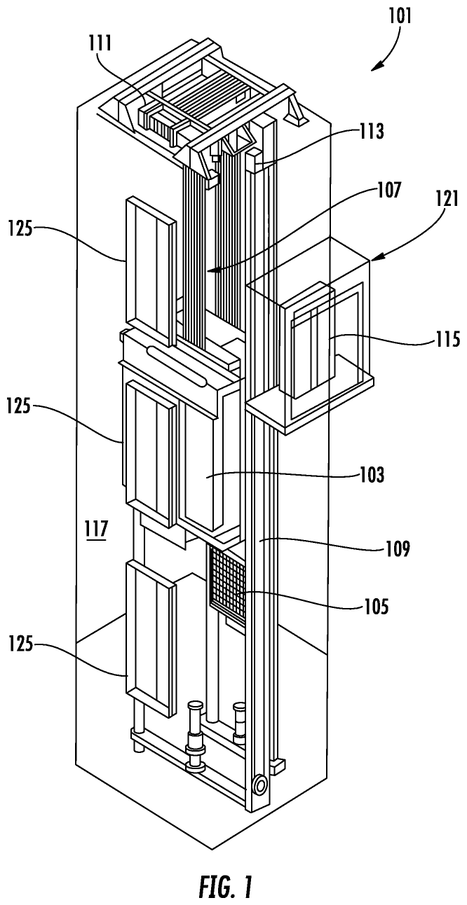

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter-weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

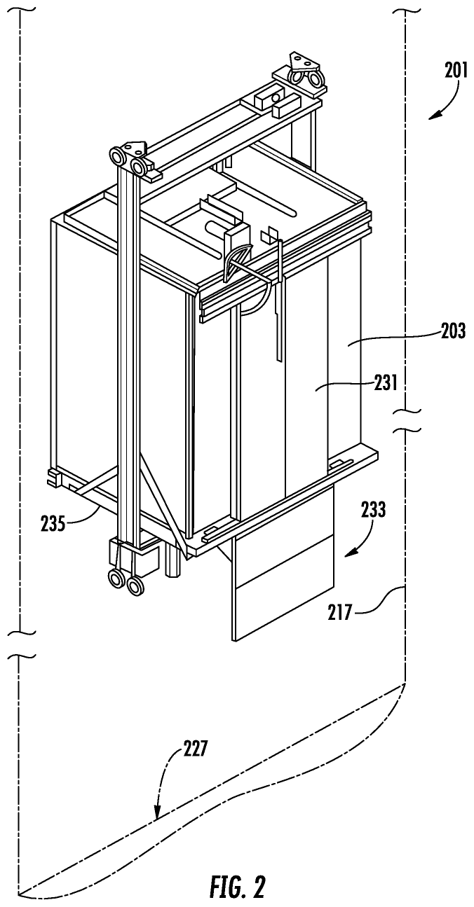

FIG. 2 is a schematic illustration of an elevator system 201 that can incorporate embodiments of the present disclosure. The elevator system 201 includes an elevator car 203 that is moveable within an elevator shaft 217. A pit floor 227 is shown at the bottom of the elevator shaft 217. The elevator car 203 includes doors elevator car doors 231 that open and close to allow ingress/egress to/from the elevator car 203 at one or more landings of the elevator system 201.

A car apron assembly 233 is provided on the elevator car 203 to cover the space between a bottom 235 of the elevator car 203 and an adjacent landing, when the elevator car 203 is in the proximity of the landing. If, for any reason, the landing doors (not shown) were to open before the elevator car 203 is properly aligned with the landing, the car apron assembly 233 is provided to at least partially block the open landing door. One function of the car apron assembly 233 is to prevent people from falling in the elevator shaft 217 during rescue operations when the elevator car door 231 is not aligned with a landing door.

However, the presence of the car apron assembly 233 impacts how close the elevator car 203 can get to the pit floor 227 of the elevator shaft 217. The example car apron assembly 233 of the present embodiment is collapsible or movable between an extended state (shown in FIG. 2) and a retracted state (not shown) that allows the elevator car 203 to descend closer to the pit floor 227 than may otherwise be possible to if the car apron assembly 233 remained in the extended state. That is, the dimensions of the car apron assembly 233 in the retracted state are significantly less than the dimensions of the car apron assembly 233 in an extended state.

In accordance with some embodiments of the present disclosure, car apron assemblies that provide full doorway coverage but also enable the use of small or low clearance pit depths in elevator systems are described. In other embodiments, the coverage provided by the car apron assemblies may be less than full coverage (e.g., ¾, ½ etc.). In accordance with embodiments of the present disclosure, car apron assemblies are arranged to close the gap between an elevator car door sill and a landing door sill using a semi-rigid curtain having a length that can extend to a value equal to the landing door opening height. The semi-rigid curtain is fixed at its upper part below the elevator car door sill and is maintained vertical during operation of the elevator car due to a weight at the lower end of the semi-rigid curtain and due to a guidance element on each side of the semi-rigid curtain. Guidance of the semi-rigid curtain may be maintained along the elevator shaft using one or more guidance elements. The semi-rigid curtain is arranged to provide a horizontal resistance (e.g., 300N, 35 mm deflection) in the event of a hazard (e.g., a person contacting the semi-rigid curtain). The semi-rigid curtain provides a constant and always deployed extension to block access to the elevator shaft below the elevator car. However, when the elevator car reaches the lowest landing, the semi-rigid curtain may crease or fold when the lower part thereof contacts the pit floor.

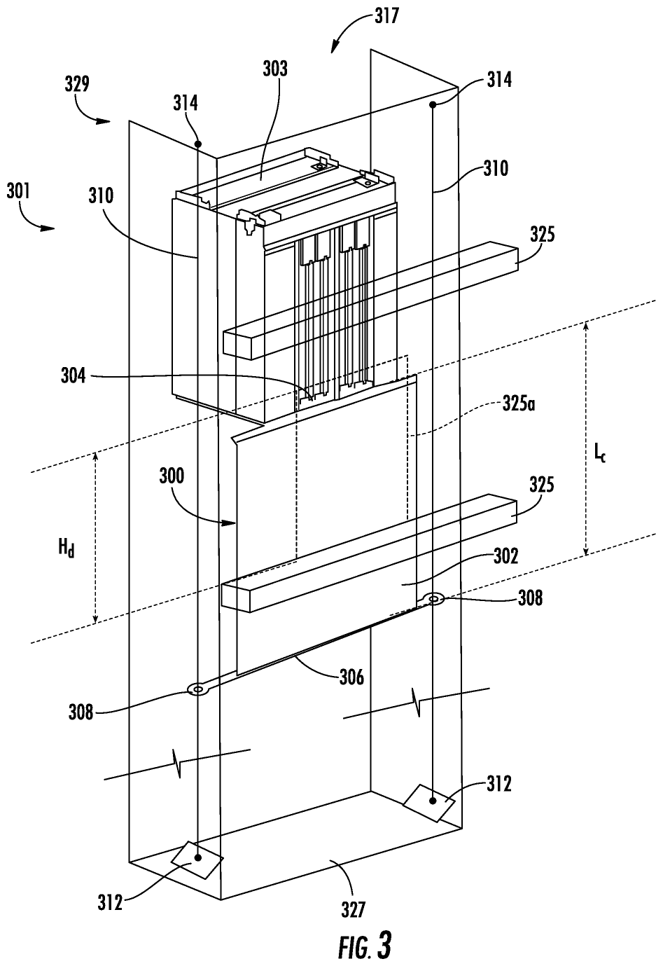

Turning now to FIG. 3, a schematic illustration of an elevator system 301 having a car apron assembly 300 in accordance with an embodiment of the present disclosure is shown. The elevator system 301 includes an elevator car 303 that is movable within an elevator shaft 317 between a number of different landings 325 along the elevator shaft. The elevator shaft 317 extends between a pit floor 327 and an elevator shaft top 329. Although not shown, the elevator car 303 is moveable along one or more guide rails and may be suspended from a roping system, as described above. At each landing 325, a landing door 325a may provide openable access to the elevator car 303, when the elevator car 303 is located at the respective landing 325.

The car apron assembly 300 includes a semi-rigid curtain 302 that is attached to and suspended from the elevator car 303. As will be appreciated by those of skill in the art, the semi-rigid curtain 302 may be attached at an elevator car door sill 304. The semi-rigid curtain 302 extends downward from and below the elevator car 303, as shown in FIG. 3. In the embodiment shown in FIG. 3, the semi-rigid curtain 302 extends from the elevator car door sill 304 to a first support element 306. The first support element 306 may provide rigidity, support, and weight to the semi-rigid curtain 302. For example, the first support element 306, in some embodiments, may be a metal rod that extends a width of the semi-rigid curtain 302 to provide a weight at the bottom of the semi-rigid curtain 302 and to ensure the semi-rigid curtain 302 remains taut and aligned with an orientation of the elevator car door sill 304 (e.g., may prevent twisting of the semi-rigid curtain 302). As such, in some embodiments, the first support element 306 may be a weighted element to apply a downward force (e.g., by gravity) on the semi-rigid curtain 302.

In this illustrative embodiment, the semi-rigid curtain 302 has a length L_{c} that is greater than a height H_{d} of a landing door. The greater dimension of the semi-rigid curtain 302 enables complete coverage or blocking of the landing door 325a if the elevator car 303 stops at a position offset from the landing door 325a (e.g., during an emergency stop). As will be appreciated by those of skill in the art, the semi-rigid curtain 302 extends downward from the elevator car 303 such that a landing door 325a that is beneath or lower along the elevator shaft 317 from the elevator car 303 is covered or blocked, even if the landing doors 325a are opened. As such, the semi-rigid curtain 302 can prevent persons or objects from falling into and/or down the elevator shaft 317, particularly during a rescue operation wherein the elevator car 303 is offset from a given landing 325. The first support element 306 is arranged to ensure positioning and rigidity to the semi-rigid curtain 302 such that the semi-rigid curtain 302 covers an open landing door 325a. In other embodiments, the length L_{c} of the semi-rigid curtain may be equal to or less than the height H_{d} of the landing door, and still provide fall-protection and safety when a landing door is opened and an elevator car is offset from the landing. In some embodiments, the length L_{c} of the semi-rigid curtain may be equal to or greater than half the height Ha of the landing door.

In addition to the first support element 306 providing rigidity and weight to the semi-rigid curtain 302, additional elements may optionally be provided to support the semi-rigid curtain 302. For example, as shown in FIG. 3, one or more second support elements 308 may engage with respective guiding elements 310. The second support elements 308 may be rigidly affixed or integrally formed with the first support elements 306. In some embodiments, the second support elements 308 are configured to engage with and move along the respective guiding elements 310. The guiding elements 310 may be ropes, wires, cords, rails, or similar structures that extend from the pit floor 327 to the elevator shaft top 329. As shown, the guiding elements 310 attach to respective base anchors 312 at the pit floor 327 and top anchors 314 at the elevator shaft top 329. The anchors 312, 314 are arranged to ensure alignment and rigidity of the guiding elements 310. The anchors 312, 314 may be dead end hitches, as will be appreciated by those of skill in the art. Although shown with a single set of second support elements 308 which are attached to or part of the first support element 306, various other arrangements are possible without departing from the scope of the present disclosure. For example, a series of second support elements may span the length L_{c} of the semi-rigid curtain 302 between the first support element 306 and the elevator car door sill 304, thus providing additional attachment/engagement points between the semi-rigid curtain 302 and the guiding elements 310.

Because the second support elements 308 of the car apron assembly 300 are engaged with the guiding elements 310, additional support or rigidity may be provided to the semi-rigid curtain 302. The guiding elements 310 provide fixed guidance along the elevator shaft 317 for the car apron assembly 300 as the elevator car 303 moves along the elevator shaft 317. In one non-limiting example, the second support elements 308 may be rings that run along the guiding elements 310 in the form of a rope or cable. In another non-limiting embodiment, the guiding elements 310 may be rails and the second support elements 308 may be guide shoes.

In one non-limiting example, the car apron assembly 300 may be arranged to meet certain predetermined criteria. For example, the length L_{c} of the semi-rigid curtain 302 may be at least two meters to ensure that a landing door opening would be covered during a rescue operation. Further, the supports 306, 308 and the material of the semi-rigid curtain 302 may be selected to prevent a specific deflection and/or impacts and thus prevent persons or objects from falling into the elevator shaft 317. For example, the car apron assembly 300 may be arranged to provide a horizontal resistance (e.g., from the landing 325 into the elevator shaft 317) of between 200-700 N with between a 5-50 mm deflection. Further, in some embodiments, the resistance may be between 300-500 N with a 15-35 mm deflection.

It is noted that in addition to providing a safety cover or protection at a landing, the car apron assembly 300 is arranged to allow for simple operation at the lowest level of the elevator shaft 317 and/or at the pit floor 327. For example, the semi-rigid curtain 302 may be collapsible such that when the first support 306 of the car apron assembly 300 contacts the pit floor 327, the semi-rigid curtain 302 may crease, collapse, or fold upon itself

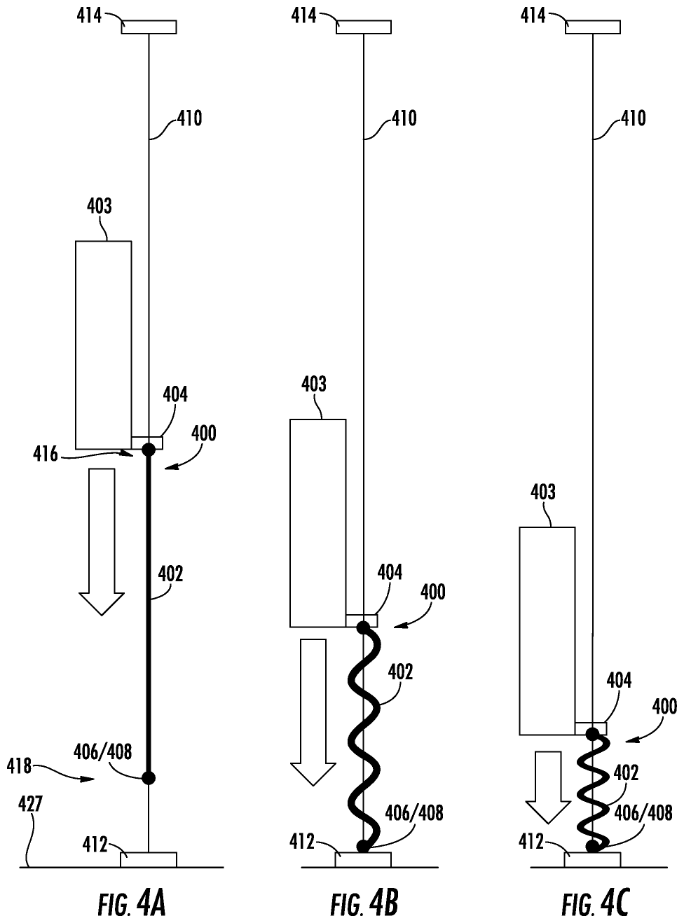

For example, turning now to FIGS. 4A-4C, schematic illustrations of a car apron assembly 400 in accordance with an embodiment of the present disclosure are shown. The car apron assembly 400 includes a semi-rigid curtain 402 that is suspended from an elevator car door sill 404 of an elevator car 403. The semi-rigid curtain 402 connects to the elevator car door sill 404 at a first end 416 and has a first support element 406 at a second end 418 thereof. Additionally, at the second end 418, the car apron assembly 400 includes one or more second support elements 408 that are arranged to engage with and move along a guiding element 410. The guiding element 410 extends between a base anchor 412 at a pit floor 427 and a top anchor 414 at a top of an elevator shaft, as shown and described above.

FIGS. 4A-4C illustrate a series of sequential schematics as the elevator car 403 approaches the bottom of the elevator shaft and thus the pit floor 427. As shown in FIG. 4A, the semi-rigid curtain 402 is fully deployed and is of sufficient length to cover a landing door, as described above. During normal operation, at all locations except proximate the pit floor 427, the semi-rigid curtain 402 will have the arrangement shown in FIG. 4A.

However, when the elevator car 403 approaches the pit floor 427, with the car apron assembly 400 installed thereto, the semi-rigid curtain 402 will contact the pit floor 427. As shown, the first and/or second support elements 406, 408 may contact the pit floor 427 and/or contact the base anchor 412. As the elevator car 403 moves downward toward the pit floor 427, as shown in FIGS. 4B-4C, the semi-rigid curtain 402 will fold, compress, or collapse without interfering with the operation of the elevator car 403. Then, when the elevator car 403 moves back upward (reverse sequence of FIGS. 4A-4C), the semi-rigid curtain 402 will extend back to the full length (FIG. 4A) without damage occurring thereto. FIG. 4C illustrates the semi-rigid curtain 402 in a folded state, and FIG. 4A illustrates the semi-rigid curtain 402 in a fully deployed state.

To enable the folding of the semi-rigid curtain, while maintaining appropriate or desirable resistance to force/impact, the semi-rigid curtain may be formed from a specific material that enables the collapsing and re-deployment and have strength thereto. For example, in some embodiments, without limitation, the semi-rigid curtain of the present disclosure may be formed from rubber, plastic (e.g., a tarp-like material, etc.), fabric (e.g., canvas, nylon, etc.), metallic and/or plastic chain links, metal or plastic mesh, etc. In some embodiments, the material of the semi-rigid curtain may be selected to ensure a relatively quiet folding when contacting the pit floor or anchors of the system. Further, the material may be selected to minimize a total weight of the car apron assembly. Moreover, the selection of the material may be made to ensure that in a folded state the semi-rigid curtain may fold into a preset space, and yet extend to a full length in normal operation. For example, in one non-limiting example, the semi-rigid curtain may have a deployed length of greater than 1 meter, and a collapsed or folded dimension of less than 400 mm. Further, in some non-limiting embodiments, the deployed length may be between 0.5 and 3 meters and the collapsed dimension may be between 200 and 450 mm. Further still, in some embodiments, the deployed length may be about 2 meters and the collapsed dimension may be about 300 mm.

Advantageously, embodiments described herein provide a protective car apron assembly to prevent accidental falls into an elevator shaft when an elevator car is positioned offset from a landing. Further, advantageously, the car apron assemblies of the present disclosure can provide full falling hazard protection, enables low pits (due to foldability), may be scalable to different elevator systems, and may provide various other advantages as appreciated by those of skill in the art.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. An elevator system comprising:
an elevator car movable along an elevator shaft, the shaft having a pit floor and a shaft top, the elevator car having an elevator car door sill;
a plurality of landings arranged along the elevator shaft, wherein each landing has a landing door; and
a car apron assembly comprising:
a semi-rigid curtain attached to the elevator car door sill at a first end of the semi-rigid curtain, wherein:
the semi-rigid curtain folds from a deployed state to a folded state when contacting the pit floor, and
when in the deployed state the semi-rigid curtain extends below the elevator car to block an open landing door that is lower than the elevator car when the elevator car is positioned offset and above an adjacent landing.

2. The elevator system of claim 1, wherein the semi-rigid curtain is formed from at least one of rubber, plastic, fabric, metallic chain links, plastic chain links, metal mesh, and plastic mesh.

3. The elevator system of claim 1, the car apron assembly further comprising a first support element that is a weighted element that applies a downward force on the semi-rigid curtain.

4. The elevator system of claim 3, wherein the first support element located at a second end of the semi-rigid curtain.

5. The elevator system of claim 1, the car apron assembly further comprising at least one second support element arranged to guide the semi-rigid curtain along the elevator shaft below the elevator car.

6. The elevator system of claim 5, further comprising at least one guiding element extending between the elevator shaft top and the pit floor, wherein the at least one second support element engages with the at least one guiding element as the elevator car moves along the elevator shaft.

7. The elevator system of claim 6, wherein the at least one guiding element is a rope or cable and the at least one second support element is a ring that slides along the rope or cable.

8. The elevator system of claim 6, wherein the at least one guiding element is a guide rail and the at least one second support element is a guide shoe that engages and moves along the guide rail.

9. The elevator system of claim 6, wherein the at least one guiding element attaches to a top anchor at the elevator shaft top and a base anchor at the pit floor.

10. The elevator system of any of claim 1, wherein the semi-rigid curtain provides a horizontal resistance of between 200-700 N with a 5-50 mm deflection, in particular with a horizontal resistance of about 300 N with about a 35 mm deflection.

11. The elevator system of claim 1, wherein the semi-rigid curtain has a length of between 1 and 5 meters in the deployed state and between 0 and 500 mm in the folded state, in particular having a length of about 2 meters in the deployed state and about 300 mm in the folded state.

12. The elevator system of claim 1, wherein each landing door has a height H_{d} and the semi-rigid curtain has a length L_{c}, wherein the curtain length L_{c}, is equal to or greater than half the landing door height H_{d}, in particular wherein the curtain length L_{c}, is greater than the landing door height H_{d}.

13. The elevator system of claim 7, wherein the at least one guiding element attaches to a top anchor at the elevator shaft top and a base anchor at the pit floor.

14. The elevator system of claim 8, wherein the at least one guiding element attaches to a top anchor at the elevator shaft top and a base anchor at the pit floor.

15. The elevator system of claim 3, the car apron assembly further comprising at least one second support element arranged to guide the semi-rigid curtain along the elevator shaft below the elevator car.

16. The elevator system of claim 15, further comprising at least one guiding element extending between the elevator shaft top and the pit floor, wherein the at least one second support element engages with the at least one guiding element as the elevator car moves along the elevator shaft.

17. The elevator system of any of claim 2, wherein the semi-rigid curtain provides a horizontal resistance of between 200-700 N with a 5-50 mm deflection, in particular with a horizontal resistance of about 300 N with about a 35 mm deflection.

18. The elevator system of claim 2, wherein the semi-rigid curtain has a length of between 1 and 5 meters in the deployed state and between 0 and 500 mm in the folded state, in particular having a length of about 2 meters in the deployed state and about 300 mm in the folded state.

19. The elevator system of claim 2, wherein each landing door has a height H_{d} and the semi-rigid curtain has a length L_{c},wherein the curtain length L_{c}is equal to or greater than half the landing door height H_{d}, in particular wherein the curtain length is greater than the landing door height H_{d}.
